(19) United States
(12) Patent Application Publication
(10) Pub. No.: US 2025/0261256 A1
(43) Pub. Date: Aug. 14, 2025

(54) Network Nodes and Methods for Handling Masked IMEISV in a Wireless Communication Network

(71) Applicant: Telefonaktiebolaget LM Ericsson (publ), Stockholm (SE)

(72) Inventors: Jie Chen, Beijing (CN); Yazid Lyazidi, Hässelby (SE); Nianshan Shi, Järfälla (SE)

(21) Appl. No.: 18/856,996

(22) PCT Filed: May 31, 2023
(86) PCT No.: PCT/SE2023/050537

§ 371 Date: Oct. 15, 2024

Related U.S. Application Data
(60) Provisional application No. 63/366,151, filed on Jun. 10, 2022.

(51) Int. Cl. H04W 76/14; H04W 8/20; H04W 12/02; H04W 12/71; H04W 72/231; H04W 76/28

(52) U.S. Cl. CPC H04W 76/14; H04W 8/20; H04W 12/02; H04W 12/71; H04W 72/231; H04W 76/28

(57) ABSTRACT

Network nodes and methods therein for handling masked International Mobile station Equipment Identity and Software Version Number (IMEISV) information for a user equipment (UE) in a wireless communication network are disclosed. A core 5 network node receives (409) a message via Control Plane (CP) signalling from a network node and sends (410) a message comprising masked IMEISV information for the UE via the CP signaling to the network node. The network node receives the message comprising masked IMEISV information for the UE via the CP signalling from the core network node and determines characteristics of the UE for 10 subsequent handling based on the masked IMEISV information.

### TECHNICAL FIELD

Embodiments herein relate to network nodes and methods therein. In particular, they relate to handling a masked International Mobile station Equipment Identity and Software Version Number (IMEISV) message for Internet of Things (IoT) user equipment in Evolved-Universal Terrestrial Radio Access Network (E-UTRAN).

### BACKGROUND

In a typical wireless communication network, wireless devices, also known as wireless communication devices, mobile equipment (ME), mobile stations (STA) and/or user equipment (UE), communicate via a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a “NodeB” or “eNodeB” or “gNB”.

A Universal Mobile Telecommunications System (UMTS) is a third generation (3G) telecommunication network, which evolved from the second generation (2G) Global System for Mobile Communications (GSM). Specifications for the Evolved Packet System (EPS), also called a Fourth Generation (4G) network or Long Term Evolution (LTE) have been completed within the 3rd Generation Partnership Project (3GPP) and this work continues in the coming 3GPP releases, for example to specify a Fifth Generation (5G) New Radio (NR) network and upcoming releases.

In 3GPP releases Rel-15/16, support of Internet of Things (IoT) was specified in Evolved-Universal Terrestrial Radio Access Network (E-UTRAN).

The E-UTRA connected to 5G Core (5GC) network is supported as part of Next Generation Radio Access Network (NG-RAN), where the term “ng-eNB” is used for E-UTRA connected to 5GC network. The E-UTRA can be connected to both Evolved Packet Core (EPC) network and 5GC network.

E-UTRA connected to 5GC network supports the following functions:
5G non-access stratum (NAS) message transport, see clause 7.3 of 3GPP TS 36.300 v16.8.0;
5G security framework, see 3GPP TS 38.300 v16.8.0 [79], except that data integrity protection is not supported;
Access Control, see 3GPP TS 38.300 v16.8.0 [79];
Flow-based Quality of Service (QOS), see 3GPP TS 38.300 v16.8.0 [79];
Network slicing, see 3GPP TS 38.300 v16.8.0 [79];
Service Data Adaptation Protocol (SDAP), see 3GPP TS 37.324 [80], except for Narrow Band IoT (NB-IoT);
NR Packet Data Convergence Protocol (PDCP), see 3GPP TS 38.323 [81], except for NB-IoT;
Support of UEs in Radio Resource Control INACTIVE (RRC_INACTIVE) state, except for NB-IoT;
Cellular IoT (CloT) 5G system (5GS) Optimisations for Bandwidth reduced Low complexity UEs (BL UEs), UEs in enhanced coverage and NB-IoT UEs, see clause 7.3a of 3GPP TS 36.300 v16.8.0;
Mobile-Originated Early Data Transmission (MO-EDT) for BL UEs, UEs in enhanced coverage and NB-IoT UEs, see clause 7.3b of 3GPP TS 36.300 v16.8.0;
Transmission using Preconfigured Uplink Resource (PUR) for BL UEs, UEs in enhanced coverage and NB-IoT UEs see clause 7.3d of 3GPP TS 36.300 v16.8.0.

### CloT Signalling Reduction Optimisations

In order to reduce the total number of control plane messages when handling a short data transaction, user data or SMS messages is conveyed to the IoT services via MME by encapsulating them in NAS messages.

LTE TS 36.300 v16.8.0 also specifies the functionalities of UE supporting/using only the CloT EPS/5GS Control Plane optimization solution as cited in the following:

### 7.3a.1 General

Which solution of CloT signalling reduction optimisations to be used is configured over NAS signalling between the UE and the MME or the AMF.
For NB-IoT, PDCP is not used while AS security is not activated.

### 7.3a.2 Control Plane CloT EPS/5GS Optimisation

The RRC connection established for Control Plane CloT EPS optimisation, as defined in TS 24.301 [20], and Control Plane CloT 5GS Optimisation, as defined in TS 24.501 [91], are characterized as below:
A UL NAS signalling message or UL NAS message carrying data can be transmitted in a UL RRC container message (see FIG. 7.3a.2-1). A DL NAS signalling or DL NAS data can be transmitted in a DL RRC container message;
for NB-IoT:
RRC connection reconfiguration is not supported;
Data radio bearer (DRB) is not used;
AS security is not used;
A non-anchor carrier can be configured for all unicast transmissions during RRC connection establishment or re-establishment.
There is no differentiation between the different data types (i.e. IP, non-IP or SMS) in the AS.
   IMEISV from TS 23.003 v17.5.0

The structure and allocation principles of the International Mobile station Equipment Identity and Software Version number (IMEISV) and the International Mobile station Equipment Identity (IMEI) are defined below.

The Mobile Station Equipment is uniquely defined by the IMEI or the IMEISV.
The International Mobile station Equipment Identity (IMEI) is composed as shown in FIG. 1, structure of IMEI. The IMEI number is a unique 15-digit code that precisely identifies the device and assigned to each and every device all over the world.
The International Mobile station Equipment Identity and Software Version Number (IMEISV) is composed as shown in FIG. 2, structure of IMEISV.

The IMEISV comprises 16 digits and is composed of the following elements, each element shall consist of decimal digits only:
Type Allocation Code (TAC). Its length is 8 digits;
Serial Number (SNR) is an individual serial number uniquely identifying each equipment within each TAC. Its length is 6 digits;
Software Version Number (SVN) identifies the software version number of the mobile equipment. Its length is 2 digits.

### Allocation Principles:

The Type Allocation Code (TAC) is issued by the GSM Association in its capacity as the Global Decimal Administrator. Further information can be found in the GSMA TS.06.

Manufacturers shall allocate individual serial numbers (SNR) in a sequential order.

For a given ME, the combination of TAC and SNR used in the IMEI shall duplicate the combination of TAC and SNR used in the IMEISV.

The Software Version Number is allocated by the manufacturer. SVN value 99 is reserved for future use.

In 3GPP specifications TS 36.413 v16.9.0, the IMEISV value is signalled with a mask from the MME to eNB during the INITIAL CONTEXT SETUP REQUEST and HANDOVER REQUST messages defined by information element (IE) “Masked IMEISV”. The IE “Masked IMEISV” contains the IMEISV value with a mask. The masked IMEISV is used to identify a terminal model without identifying an individual Mobile Equipment.

In 3GPP specifications TS 38.413 v16.9.0, the masked IMEISV is signalled in the same equivalent messages from AMF to ng-eNB.

The masked IMEISV is coded as the International Mobile station Equipment Identity and Software Version Number (IMEISV) defined in TS 23.003 v17.5.0 with the last 4 digits of the SNR masked by setting the corresponding bits to 1. The first to fourth bits correspond to the first digit of the IMEISV, the fifth to eighth bits correspond to the second digit of the IMEISV, and so on.

In the following, the terms “communication device”, “UE”, “ME” are used interchangeably. The term “base station”, “network node”, “gNB”, “eNB”, “gNodeB”, “ng-eNB” are used interchangeably.

### SUMMARY

As part of developing embodiments herein problems were identified and will first be discussed.

For a UE that supports only the Control Plane CloT EPS optimization or Control Plane (CP) CloT 5GS optimization, the RRC connection reconfiguration is not supported and Access Stratum (AS) security is not used. This creates an issue since the eNB in case of E-UTRAN connected to EPC network, or the ng-eNB in case of E-UTRAN connected to 5GC or NG-RAN network cannot receive masked IMEISV due to the lack of AS security context.

Therefore, it is an object of embodiments herein to provide a method for handling of masked IMEISV information for UEs in a wireless communication network.

The S1 Application Protocol (S1-AP) is defined in TS 36.413 v16.9.0. The NG Application Protocol (NG-AP) is defined in TS 38.413 v16.9.0. It provides the control plane signalling between NG-RAN node and Access and Mobility Management Function (AMF). Embodiments herein explore S1-AP and NG-AP messages for signalling the masked IMEISV information for UEs that supports only the Control Plane CloT EPS optimization or Control Plane (CP) CloT 5GS optimization.

According to one aspect of the embodiments herein, the object is achieved by a core network node and method therein for handling of masked IMEISV information for a UE in a wireless communication network.

The core network receives a message via Control Plane (CP) signalling from a network node and sends a message comprising masked IMEISV information for the UE via the CP signaling to the network node.

According to one aspect of the embodiments herein, the object is achieved by a network node and method therein for handling of masked IMEISV information for a UE in a wireless communication network.

The network node receives a message comprising masked IMEISV information for the UE via Control Plane (CP) signalling from a core network node and determines characteristics of the UE for subsequent handling based on the masked IMEISV information.

According to some embodiments, the core network node, e.g. MME or AMF, may signal the masked IMEISV information into the UE INFORMATION TRANSFER message in S1-AP and NG-AP, triggered by RETRIEVE UE INFORMATION message, so that the E-UTRAN/NG-RAN network node can retrieve the information from the core network.

According to some embodiments, the core network node e.g. MME or AMF, may signal the masked IMEISV information into the S1-AP or NG-AP CONNECTION ESTABLISHMENT INDICATION message to complete the establishment of the UE-associated logical S1 or NG-connection, and provide to the E-UTRAN or NG-RAN network node the Masked IMEISV.

According to some embodiments, the core network node e.g. MME or AMF, may signal the masked IMEISV information into the DL NAS TRANSPORT message for carrying NAS information over the S1 or NG interface.

According to some embodiments, the core network node e.g. MME or AMF, may signal the masked IMEISV information into the CP RELOCATION INDICATION messages to inform the E-UTRAN or NG-RAN network node that the UE with the masked IMEISV is to be relocated.

In other words, according to the embodiments herein the masked IMEISV may be signaled in any one of the S1-AP messages such as UE INFORMATION TRANSFER, DL NAS TRANSPORT, MME CP RELOCATION INDICATION and the CONNECTION ESTABLISHMENT INDICATION messages from MME to eNB.

The masked IMEISV may also be signaled in any one of the NG-AP messages such as UE INFORMATION TRANSFER, DL NAS TRANSPORT, AMF CP RELOCATION INDICATION and the CONNECTION ESTABLISHMENT INDICATION messages from AMF to ng-eNB.

Embodiments herein allow UE function verification by E-UTRAN/NG-RAN network node for IoT UEs supporting only CP CloT EPS/5GS optimization, such as the possibility to activate/deactivate some features for some specific UE issues based on the masked IMEISV information.

Therefore embodiments herein provide an improved method for handling masked IMEISV for UEs in a wireless communication network.

### BRIEF DESCRIPTION OF THE DRAWINGS

Examples of embodiments herein are described in more detail with reference to attached drawings in which:

FIG. 1 is a schematic block diagram illustrating structure of IMEI;

FIG. 2 is a schematic block diagram illustrating structure of IMEISV;

FIG. 3 is a schematic block diagram illustrating a wireless communication network;

FIG. 4 is a signal flow chart illustrating an example embodiment of a method for handling masked IMEISV information for UEs according to embodiments herein;

FIG. 5 is a schematic block diagram illustrating an example embodiment of a core network node; and

FIG. 6 is a schematic block diagram illustrating an example embodiment of a network node or base station.

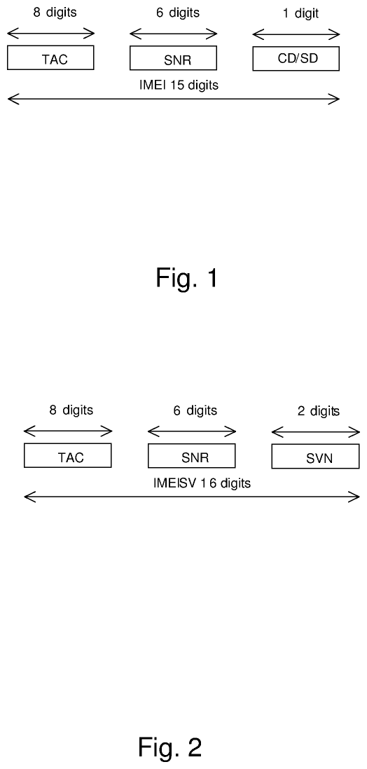

### DETAILED DESCRIPTION

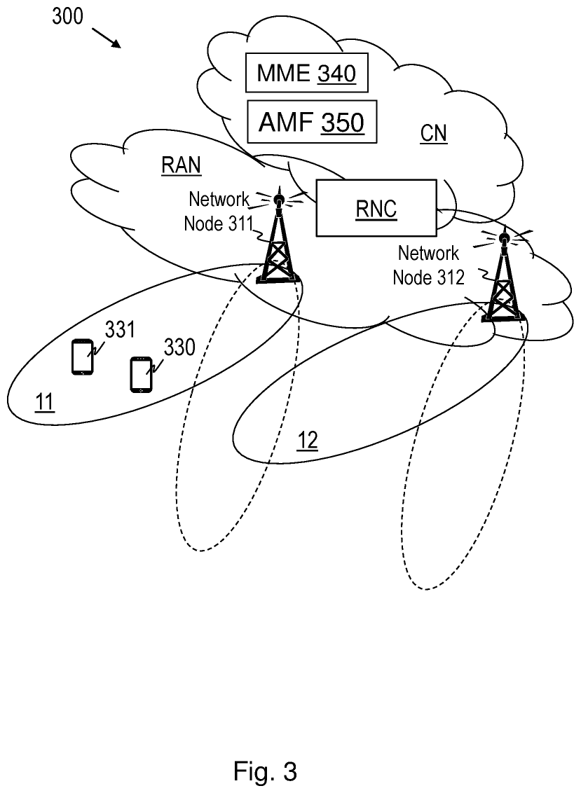

Embodiments herein relate to communications networks in general. FIG. 3 is a schematic overview depicting a communication network 300. The communication network 300 may be a wireless communications network comprising one or more RANs, and one or more CNs. The communication network 300 may use a number of different technologies, such as Wi-Fi, Long Term Evolution (LTE), LTE-Advanced, NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), E-UTRAN, NG-RAN just to mention a few possible implementations.

In the wireless communication network 300, one or more wireless communication devices 330, 331 such as a UE, a mobile station or a wireless terminals communicates via one or more Radio Access Networks (RAN) to one or more core networks (CN). It should be understood by the skilled in the art that “wireless communication device” is a non-limiting term which means any wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

The one or more wireless communication devices or UEs 330, 331 may be IoT UEs supporting only CP CloT EPS/5GS optimization.

Network nodes operate in the wireless communication network 300 such as a first network node 311 and a second network node 312. The first and second network node 311, 312 may be any of RAN node, such as gNB, eNB, en-gNB, ng-eNB, gNB etc. The first network node 311 provides radio coverage over a geographical area, a service area 11, which may also be referred to as a beam or a beam group where the group of beams is covering the service area of a first radio access technology (RAT), such as 5G, LTE, Wi-Fi or similar. The second network node 312 provides radio coverage over a geographical area, a service area 12, which may also be referred to as a beam or a beam group where the group of beams is covering the service area of a first or a second radio access technology (RAT), such as 5G, LTE, Wi-Fi or similar.

The first and second network nodes 311 and 312 may be a transmission and reception point e.g. a radio access network node such as a Wireless Local Area Network (WLAN) access point or an Access Point Station (AP STA), an access controller, a base station, e.g. a radio base station such as a NodeB, a gNB, an evolved Node B (eNB, eNode B), a base transceiver station, a radio remote unit, an Access Point Base Station, a base station router, a transmission arrangement of a radio base station, a stand-alone access point or any other network unit capable of communicating with a wireless communication device within the service area served by the respective first and second network nodes 311 and 312 depending e.g. on the radio access technology and terminology used.

The wireless communication network 300 may further comprise an MME 340 in case of 4G LTE network, or an AMF 350 in case of 5GC network. AMF 350 is a control plane function in 5G core network and is also responsible for handling NG-AP signalling which is transferred between the AMF 350 and 5G RAN node, e.g. the first or second network node 311, 312. NG-AP specifications are described in 3GPP TS 38.413 and is similar to S1-AP in case of 4G LTE. S1-AP provides the control plane signalling between E-UTRAN network node and EPC. The interface is S1-MME which is located between eNB e.g. the first or second network node 311, 312 and MME 340.

### S1-AP Embodiments

In one embodiment, after receiving the RETRIEVE UE INFORMATION message from eNB, the MME 340 signals the masked IMEISV Information element for the IoT UE via the UE INFORMATION TRANSFER message.

Without loss of generality, an example to TS 36.413 is provided below with bold text:
9.1.4.22 UE INFORMATION TRANSFER
   The message is sent by the MME to transfer UE information over the S1 interface.

### Direction: MME→eNB

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.2.1.1 | | YES | reject |
| S-TMSI | M | 9.2.3.6 | | YES | reject |
| UE Level QoS | O | E-RAB Level | Includes | YES | ignore |
| Parameters | | QoS | QoS | | |
| | | Parameters | parameters. | | |
| | | 9.2.1.15 | | | |
| UE Radio Capability | O | 9.2.1.27 | | YES | ignore |
| Subscription Based | O | 9.2.1.140 | | YES | ignore |
| UE Differentiation | | | | | |
| Information | | | | | |
| Pending Data | O | 9.2.3.55 | | YES | ignore |
| Indication | | | | | |
| Masked IMEISV | O | 9.2.3.38 | | YES | ignore |

Upon reception, the eNB shall, if supported, use masked IMEISV to determine the characteristics of the UE for subsequent handling.

In another embodiment the masked IMEISV may be signalled within the Subscription Based UE Differentiation Information.

In one embodiment, the MME 340 may signal the masked IMEISV in the CONNECTION ESTABLISHMENT INDICATION message to eNB.

Without loss of generality, an example to TS 36.413 is provided below with bold text:
9.1.4.20 CONNECTION ESTABLISHMENT INDICATION
   This message is sent by the MME to complete the establishment of the UE-associated logical S1-connection.

### Direction: MME→eNB

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.2.1.1 | | YES | reject |
| MME UE S1AP ID | M | 9.2.3.3 | | YES | ignore |
| eNB UE S1AP ID | M | 9.2.3.4 | | YES | ignore |
| UE Radio Capability | O | 9.2.1.27 | | YES | ignore |
| Enhanced Coverage | O | 9.2.1.123 | | YES | ignore |
| Restricted | | | | | |
| DL CP Security | O | 9.2.3.49 | | YES | ignore |
| Information | | | | | |
| CE-Mode-B | O | 9.2.1.129 | | YES | ignore |
| Restricted | | | | | |
| End Indication | O | 9.2.3.54 | | YES | ignore |
| Subscription Based | O | 9.2.1.140 | | YES | ignore |
| UE Differentiation | | | | | |
| Information | | | | | |
| UE Level QoS | O | E-RAB | Includes | YES | ignore |
| Parameters | | Level QoS | QoS | | |
| | | Parameters | parameters. | | |
| | | 9.2.1.15 | | | |
| UE Radio Capability | O | 9.2.1.153 | | YES | reject |
| ID | | | | | |
| Masked IMEISV | O | 9.2.3.38 | | YES | ignore |

In another embodiment, the masked IMEISV may be signalled in the following S1-AP messages:
MME CP RELOCATION INDICATION
NGAP DOWNLINK NAS TRANSPORT

### NG-AP Embodiments

In one embodiment, after receiving the RETRIEVE UE INFORMATION message from ng-eNB, the AMF 350 signals the masked IMEISV Information element for the IoT UE via the UE INFORMATION TRANSFER message.

Without loss of generality, an example to TS 38.413 is provided below with bold text:
9.2.2.15 UE INFORMATION TRANSFER
   The message is sent by the AMF to transfer UE information over the NG interface.
   Direction: AMF→NG-RAN node

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.3.1.1 | | YES | reject |
| 5G-S-TMSI | M | 9.3.3.20 | | YES | reject |
| NB-IoT UE | O | 9.3.1.145 | | YES | ignore |
| Priority | | | | | |
| UE Radio | O | 9.3.1.74 | | YES | ignore |
| Capability | | | | | |
| S-NSSAI | O | 9.3.1.24 | | YES | ignore |
| Allowed NSSAI | O | 9.3.1.31 | Indicates the | YES | ignore |
| | | | S-NSSAIs | | |
| | | | permitted by | | |
| | | | the network | | |
| UE | O | 9.3.1.144 | | YES | ignore |
| Differentiation | | | | | |
| Information | | | | | |
| Masked IMEISV | O | 9.3.1.54 | | YES | ignore |

Upon reception, the ng-eNB shall, if supported, use the Masked IMEISV to determine the characteristics of the UE for subsequent handling.

In another embodiment the Masked IMEISV may be signalled within UE Differentiation Information.

In one embodiment, the AMF 350 may signal the masked IMEISV in the CONNECTION ESTABLISHMENT INDICATION message to eNB.

Without loss of generality, an example to TS 38.413 is provided below with bold text:
9.2.2.11 CONNECTION ESTABLISHMENT INDICATION
   This message is sent by the AMF to complete the establishment of the UE-associated logical NG-connection.
   Direction: AMF→NG-RAN node

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.3.1.1 | | YES | reject |
| AMF UE NGAP ID | M | 9.3.3.1 | | YES | reject |
| RAN UE NGAP ID | M | 9.3.3.2 | | YES | reject |
| UE Radio Capability | O | 9.3.1.74 | | YES | ignore |
| End Indication | O | 9.3.3.32 | | YES | ignore |
| S-NSSAI | O | 9.3.1.24 | | YES | ignore |
| Allowed NSSAI | O | 9.3.1.31 | Indicates | YES | ignore |
| | | | the S- | | |
| | | | NSSAIs | | |
| | | | permitted by | | |
| | | | the network | | |
| UE Differentiation | O | 9.3.1.144 | | YES | ignore |
| Information | | | | | |
| DL CP Security | O | 9.3.3.49 | | YES | ignore |
| Information | | | | | |
| NB-IoT UE Priority | O | 9.3.1.145 | | YES | ignore |
| Enhanced Coverage | O | 9.3.1.140 | | YES | ignore |
| Restriction | | | | | |
| CE-mode-B | O | 9.3.1.155 | | YES | ignore |
| Restricted | | | | | |
| UE Radio Capability | O | 9.3.1.142 | | YES | reject |
| ID | | | | | |
| Masked IMEISV | O | 9.3.1.54 | | YES | Masked |
| | | | | | IMEISV |

In another embodiment, the masked IMEISV may be signalled in the following NG-AP messages:
AMF CP RELOCATION INDICATION
NGAP DOWNLINK NAS TRANSPORT

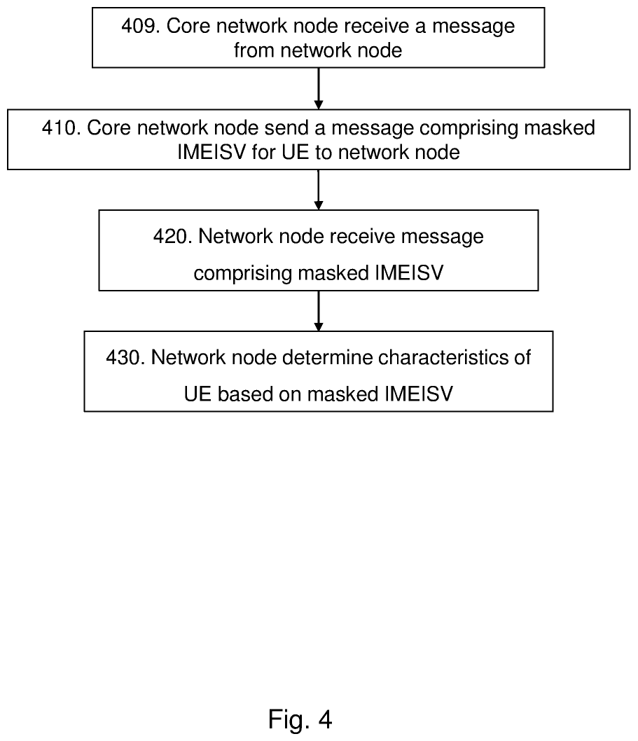

According to embodiments herein a method for handling a masked IMEISV for a UE in the wireless communication network 300 is developed based on the above examples. The method will be described with reference to FIG. 4. The method comprises the following actions which action may be performed in any suitable order.

### Action 409

The core network node MME 340/AMF 350 receives a message via CP signalling from a network node 311/312. For example, the core network node MME 340/AMF 350 may receive RETRIEVE UE INFORMATION message from the network node 311/312 via the CP signalling.

### Action 410

The core network node MME 340/AMF 350 signals a masked IMEISV for a UE in a message via S1-AP interface or NG-AP interface to a network node or base station 311/312. That is the core network node MME 340/AMF 350 sends a message comprising masked IMEISV information for the UE via the CP signaling to the network node 311/312.

The core network node 340/350 may be a MME node 340 in case the wireless communication network 300 is a 4G LTE network or a AMF node 350 in case the wireless communication network 300 is a 5GC network.

The message may be any one of:
a) UE INFORMATION TRANSFER
b) CONNECTION ESTABLISHMENT INDICATION
c) Subscription Based UE Differentiation Information/UE Differentiation Information
d) MME/AMF CP RELOCATION INDICATION
e) NGAP DOWNLINK NAS TRANSPORT

### Action 420

The network node or base station 311/312 receives a message comprising masked IMEISV for a UE from the core network node 340/350.

### Action 430

The network node or base station 311/312 determines the characteristics of the UE for subsequent handling based on the masked IMEISV received from the core network node 340/350. According to some embodiments herein, the characteristics of the UE may comprise specific feature support status of the UE indicated by the masked IMEISV information.

According to some embodiments herein, the subsequent handling may comprise any one of turning off Connected Mode Discontinuous reception (CDRX), turning off fast Radio Resource Control (RRC) release etc.

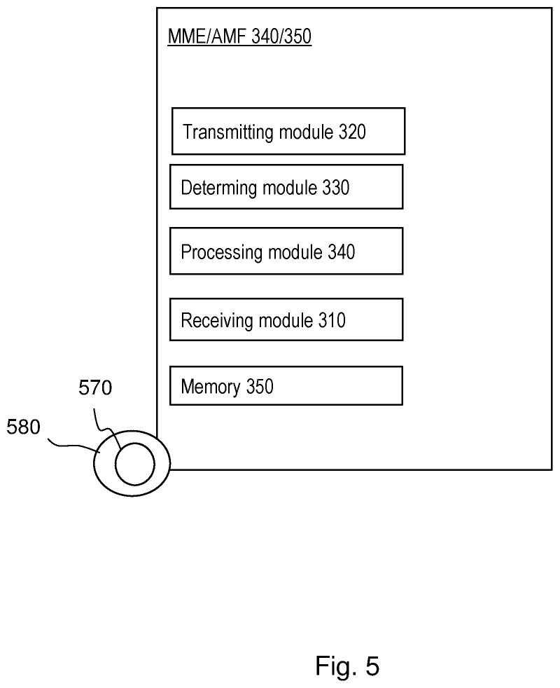

To perform the method in the core network node 340/350, the core network node 340/350 comprises modules as shown in FIG. 5. The core network node 340/350 comprises a receiving module 510, a transmitting module 520, a determining module 530, a processing module 540, a memory 550 etc.

The core network node 340/350 is configured to perform the Actions 409, 410, i.e. receiving a message via CP signalling from a network node or base station 311/312 and signaling a masked IMEISV for a UE in a message via S1-AP interface or NG-AP interface to the network node or base station 311/312.

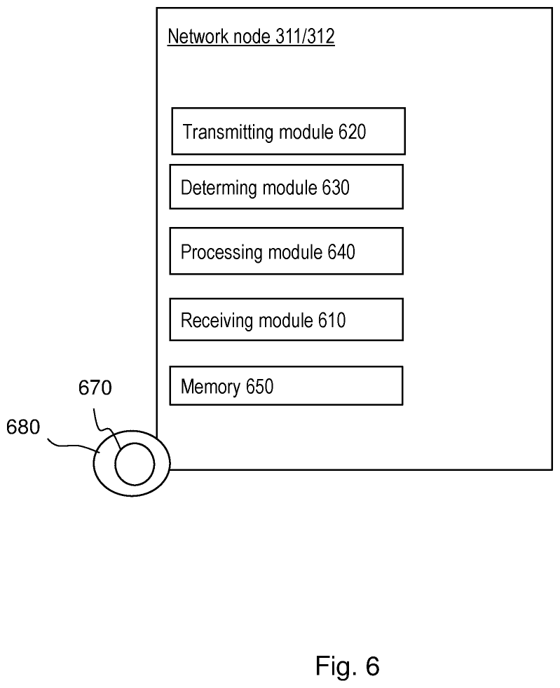

To perform the method in the network node/base station 311/312, the network node/base station 311/312 comprises modules as shown in FIG. 6. The network node/base station 311/312 comprises a receiving module 610, a transmitting module 620, a determining module 630, a processing module 640, a memory 650 etc.

The network node/base station 311/312 is configured to perform the Actions 420-430, i.e. receiving a masked IMEISV for a UE in a message via S1-AP interface or NG-AP interface and determining the characteristics of the UE for subsequent handling based on the masked IMEISV received.

The method according to embodiments herein may be implemented through one or more processors, such as the processor 540/640 in the core network node 340/350 or base station 311/312 together with computer program code for performing the functions and actions of the embodiments herein. The program code mentioned above may also be provided as a computer program product, for instance in the form of computer readable medium or a data carrier 580/680 carrying computer program code 570/670, as shown in FIG. 5/6, for performing the embodiments herein when being loaded into the core network node 340/350 or base station 311/312. One such carrier may be in the form of a CD ROM disc. It is however feasible with other data carriers such as a memory stick. The computer program code may furthermore be provided as pure program code on a server or a cloud and downloaded to the core network node 340/350 or base station 311/312.

Some example embodiments are listed in the following:

Embodiment 1: A method performed by a core network node 340/350 for handling masked IMEISV for a UE in a wireless communication network 300, the method comprising:
receiving (409) a message via Control Plane (CP) signalling from a network node 311/312; and
sending (410) a message comprising masked IMEISV information for the UE via the CP signaling to the network node 311/312.
   Embodiment 2: The method of Embodiment 1, wherein the core network node 340/350 is a MME node 340 or a AMF node 350.
   Embodiment 3: The method of Embodiments 1-2, wherein the message comprising masked IMEISV information is any one of:
a) UE INFORMATION TRANSFER
b) CONNECTION ESTABLISHMENT INDICATION
c) Subscription Based UE Differentiation Information orUE Differentiation Information
d) CP RELOCATION INDICATION
e) DOWNLINK NAS TRANSPORT
   Embodiment 4: A method performed by a network node or base station (340/350) for handling masked IMEISV in a wireless communication network 300, the method comprising:
receiving (420) a message comprising masked IMEISV for a UE via CP signaling from a core network node (340/350), such as S1-AP interface or NG-AP interface; and
determining (430) characteristics of the UE for subsequent handling based on the masked IMEISV information received.
   Embodiment 5: The method of Embodiments 1-4, wherein the UE is an IoT UE supporting only the Control Plane CloT EPS optimization or Control Plane (CP) CloT 5GS optimization.

1.-16. (canceled)

17. A method performed by a core network node in a wireless communication network, the method comprising:
receiving a message via control plane (CP) signaling from a network node in the wireless communication network; and
sending, to the network node via CP signaling, a message comprising masked International Mobile station Equipment Identity and Software Version Number (IMEISV) information for a user equipment (UE).

18. The method according to claim 17, wherein the core network node is a Mobility Management Entity (MME) node or an Access and Mobility Management Function (AMF) node.

19. The method according to claim 17, wherein the message comprising masked IMEISV information for the UE is one of the following:
UE INFORMATION TRANSFER;
CONNECTION ESTABLISHMENT INDICATION;
Subscription Based UE Differentiation Information;
UE Differentiation Information;
CP RELOCATION INDICATION;
DOWNLINK NAS TRANSPORT.

20. A method performed by a network node in a wireless communication network, the method comprising:
receiving, via control plane (CP) signaling from a core network node in the wireless communication network, a message comprising masked International Mobile station Equipment Identity and Software Version Number (IMEISV) information for a user equipment (UE); and
based on the masked IMEISV information, determining characteristics of the UE for subsequent handling of the UE by the network node.

21. The method according to claim 20, wherein the core network node is a Mobility Management Entity (MME) node or an Access and Mobility Management Function (AMF) node.

22. The method according to claim 20, wherein the message comprising masked IMEISV information for the UE is one of the following:
UE INFORMATION TRANSFER;
CONNECTION ESTABLISHMENT INDICATION;
Subscription Based UE Differentiation Information;
UE Differentiation Information;
CP RELOCATION INDICATION;
DOWNLINK NAS TRANSPORT.

23. The method according to claim 20, wherein the determined characteristics of the UE comprise specific feature support status of the UE indicated by the masked IMEISV information.

24. The method according to claim 20, wherein the subsequent handling comprises turning off one of the following for the UE: Connected Mode Discontinuous Reception (CDRX), or fast Radio Resource Control (RRC) release.

25. The method according to claim 17, wherein one or more of the following applies:
the UE does not support access stratum (AS) security;
the UE does not support radio resource control (RRC) connection reconfiguration; and
the UE is an Internet of Things (IoT) UE supporting only Cellular IoT (CIOT) Evolved Packet System (EPS) or Fifth Generation System (5GS) Control Plane optimization.

26. A core network node configured for operation in a wireless communication network, the core network node comprising:
one or more processors; and
memory operably coupled to the one or more processors and storing executable program code that, when executed by the one or more processors, configures the network node to:
receive a message via Control Plane (CP) signaling from a network node in the wireless communication network; and
send, to the network node via CP signaling, a message comprising masked International Mobile station Equipment Identity and Software Version Number (IMEISV) information for a user equipment (UE).

27. The core network node according to claim 26, wherein the core network node is a Mobility Management Entity (MME) node or an Access and Mobility Management Function (AMF) node.

28. The core network node according to claim 26, wherein the message comprising masked IMEISV information is one of the following:
UE INFORMATION TRANSFER;
CONNECTION ESTABLISHMENT INDICATION;
Subscription Based UE Differentiation Information;
UE Differentiation Information;
CP RELOCATION INDICATION;
DOWNLINK NAS TRANSPORT.

29. A network node configured for operation in a wireless communication network, the network node comprising:
one or more processors; and
memory operably coupled to the one or more processors and storing executable program code that, when executed by the one or more processors, configures the network node to:
receive, via control plane (CP) signaling from a core network node in the wireless communication network, a message comprising masked International Mobile station Equipment Identity and Software Version Number (IMEISV) information for a user equipment (UE); and
based on the masked IMEISV information, determine characteristics of the UE for subsequent handling of the UE by the network node.

30. The network node according to claim 29, wherein the message comprising masked IMEISV information is one of the following:
UE INFORMATION TRANSFER;
CONNECTION ESTABLISHMENT INDICATION;
Subscription Based UE Differentiation Information;
UE Differentiation Information;
CP RELOCATION INDICATION;
DOWNLINK NAS TRANSPORT.

31. The network node according to claim 29, wherein the determined characteristics of the UE comprise specific feature support status of the UE indicated by the masked IMEISV information.

32. The network node according to claim 29, wherein the subsequent handling comprises turning off one of the following for the UE: Connected Mode Discontinuous Reception (CDRX), or fast Radio Resource Control (RRC) release.
